(19) United States
(12) Patent Application Publication
(10) Pub. No.: US 2017/0238127 A1
(43) Pub. Date: Aug. 17, 2017

(54) COMMUNICATION VIA DEVICE TAP

(71) Applicant: Chad Wilson, WALNUT, CA (US)

(72) Inventor: Chad Wilson, WALNUT, CA (US)

(73) Assignee: LinchPin App Inc., WALNUT, CA (US)

(21) Appl. No.: 15/430,488

(22) Filed: Feb. 12, 2017

Related U.S. Application Data
(60) Provisional application No. 62/294,927, filed on Feb. 12, 2016.

(51) Int. Cl. H04W 4/00; H04W 76/02; H04W 4/02

(52) U.S. Cl. CPC H04W 4/008; H04W 4/02; H04W 76/023

(57) ABSTRACT

Device to Device communication today is possible, but is fragmented and does not always work across device makes and models. The Communication via Tap invention works on any device to allow safe and simple communication via data points collected on each device, a server to match the devices, and the optional step of having users validate the Match before communicating.

### FIELD OF THE INVENTION

The present invention relates generally to a system and method for exchanging information between at least two or more devices in a mobile portable wireless communication system.

### BACKGROUND OF THE INVENTION

Information exchange between devices can be difficult. All solutions require some level of a priori knowledge such as a phone number for phone calls and text messages, an email address for email exchange, and social media identifiers for specific social networks. This information must be requested and communicated directly before communication can occur. If an individual receives incorrect information, then the process must be repeated. Further compounding this issue is when a user has a complex identifier for communication, but cannot simplify it due to circumstances outside their control (e.g., when all simple names have been reserved within a large ecosystem such as Twitter® or Facebook®).

What is needed, therefore, is a method of communication without extensive searching or a priori knowledge that allows for quick exchange of information. Furthermore, this method should be simple and secure, and operable without false negatives or false positive matches. In this regard, the invention described herein addresses this problem.

### SUMMARY OF THE INVENTION

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as to prelude to the more detailed description that is disclosed later.

In one embodiment, the present system comprises a server and a plurality of user devices, wherein the devices comprise mobile phones, or other types of computer systems. The devices are configured to be matched with each other so as to allow users of those devices to exchange information. Without limitation, information such as the devices' physical location, timing, devices' movement, or a combination thereof is used to generate a match between the devices. It should be understood that one embodiment of the system and method of the present invention are taught and disclosed in terms of mobile computing, but the same principles are applicable to nearly any device capable of executing machine-readable instruction. For instance, one embodiment of the present invention may comprise a first device in a fixed location. In this regard, the present system and method comprise a wide variety of applications.

### BRIEF DESCRIPTION OF THE DRAWINGS

FIG. 1 shows communication between a server and devices.

FIG. 2 shows data for Tap Event.

FIG. 3 shows uncertainty radii of a device.

FIG. 4 shows the accuracy radii of devices D₁ and D₂ when in range.

FIG. 5 shows the accuracy radii of devices D₁ and D₂ when out of range.

FIG. 6 shows time on each device at a snapshot.

FIG. 7 shows how time offset is discovered.

FIG. 8 shows direction of motion of a device and how they correspond to coordinates.

FIG. 9 shows an exemplary embodiment of Tap motion.

FIG. 10 shows an exemplary attempt to hijack a Match.

FIG. 11 shows a flow of Match validation and data transfer.

### DETAILED DESCRIPTION OF THE INVENTION

The present system allows two or more devices to be matched with each other by information that is specific to the devices at the time the devices intend to communicate. In an exemplary embodiment, the information utilized to generate a match between the devices is the same physical location, the same time, matching movement data recorded from one or more impacts (e.g., Taps). In the case of multiple Taps, the time between the each of the Taps is used to generate a unique identifier.

A match is initiated by physical contact between two or more devices. This contact is needed to provide unique data to mitigate match failures in areas where many groups of people are attempting to exchange data, because location and time alone are error prone. For the purpose of this patent the word “server” refers to any trusted third party computing device. Non-limiting examples of a server includes a single server class computer, a single virtual server, multiple servers (virtual or otherwise) in a cluster, a desktop computer, a tablet computer, a mobile phone, or other devices.

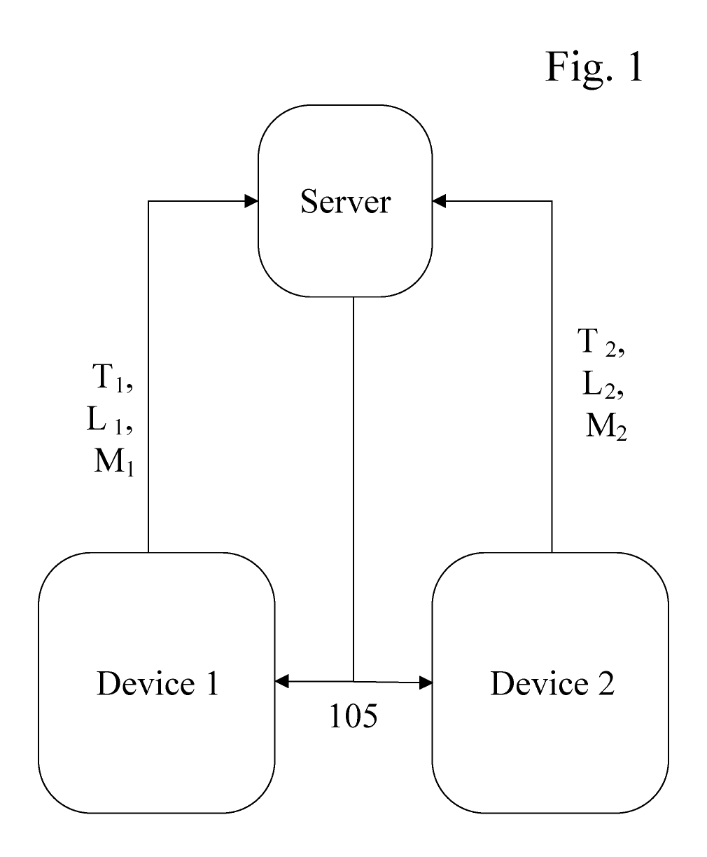

FIG. 1 illustrates the communication of Location (L), Time (T), and Motion (M) from two devices (Device 1 and Device 2 respectively). The server will then communicate back to the devices on whether the Match was successful in 105.

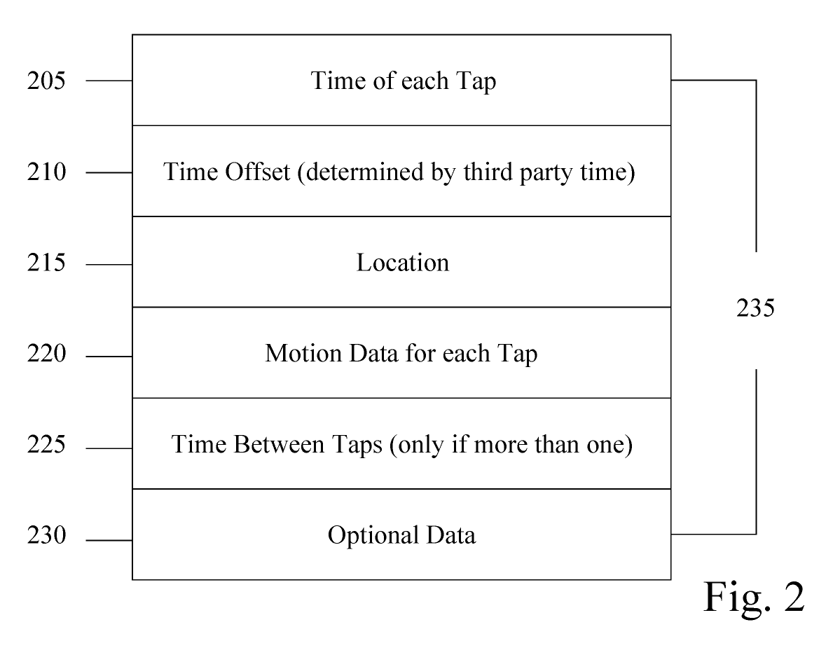

Referring now to FIG. 2, the Time of each Tap 205, the Time Offset 210 (this is a way to correct erroneous local time which will be discussed in detail later), the Location (typically as Latitude and Longitude) 215, and the Motion data 220 are shown. Optional elements in FIG. 2 include multiple Motion data records 220, the time between Taps 225, and any other optional data 230. This corresponds to the communication in FIG. 1.

The same place can be defined as two or more devices having Latitude and Longitude values within a certain threshold of distance. In one embodiment, these values can be calculated via Global Positioning Satellites (GPS), Wireless Ethernet (WiFi) triangulation, cellular network triangulation, Bluetooth triangulation, IP Address lookup, location hard coding within the device, atmospheric sensor data, or other suitable means.

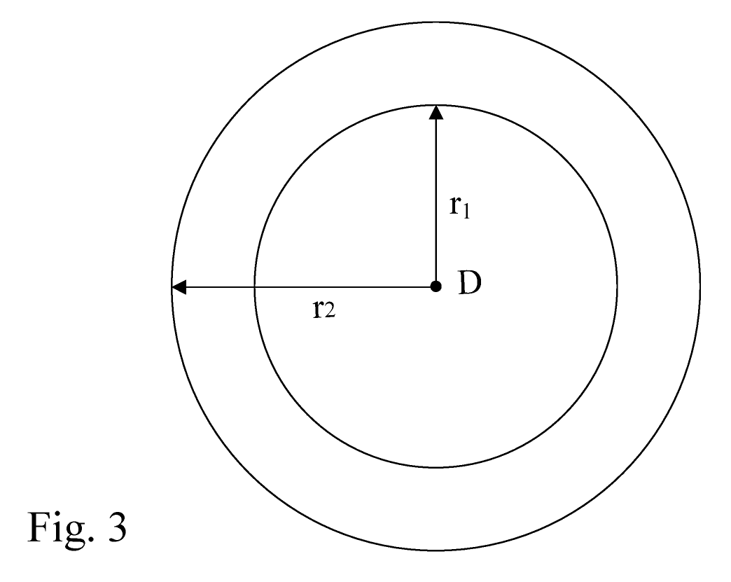

Measuring the distance between two devices that Tap is an error-prone process due to the varying accuracy of location hardware, as well as the method used to discover the location within each device. FIG. 3 shows two radii that correspond to a percentage of certainty that the location of the device D at a fixed point in time exists within the circle.

The radius r₁ in FIG. 3 corresponds to a percentage of 65% certainty. This means that the actual location of device D has a 65% probability that it exists somewhere within the circle created between radius r₁ and the point D. Radius r₂ corresponds to 95% certainty that the actual location of device D exists somewhere within the circle created between point D and the radius r₂.

Further compounding this is the fact that even though a device may have accurate measurements, often times the delay incurred by getting accurate data from the satellite network means when a Tap event occurs the location data may be stale. At best we can record the latitude and longitude of the device when a Tap event occurs, and assume that a certain level of inaccuracy exists in order to find both devices. This is also why we rely on the other data points to determine Tap partners, as there may be tens or hundreds of devices Tapping within the distance radius.

When comparing two device locations in order to generate a Match, the simplest solution is to take both uncertainty radii and add them together. If they are larger than the distance between both Device Location coordinates, then they are assumed to be a Match on the location data. This can be expressed as the equation d<r₁+r₂. Another solution is to add a variable amount of assumed error into the equation. This can be expressed as d<r₁+r₂+e.

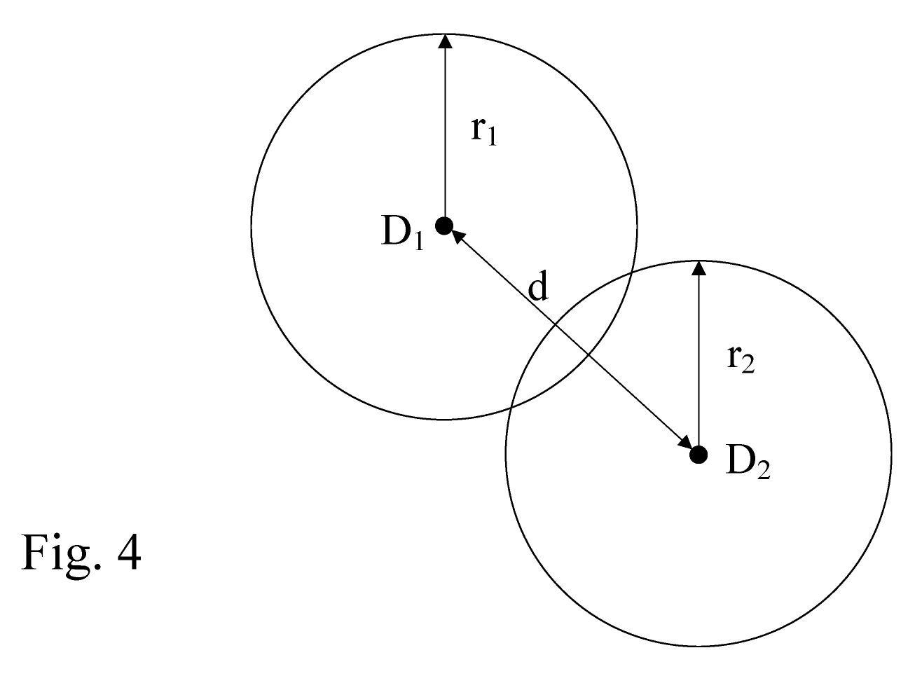

FIG. 4 shows an example of when two devices, D₁ and D₂ are a Match with their location data as distance d is less than r₁ and r₂.

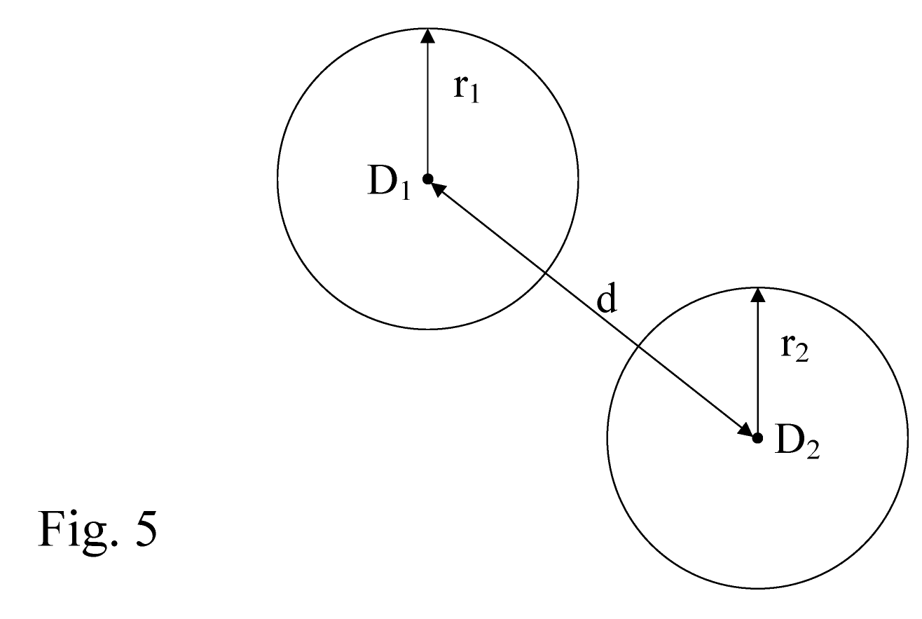

FIG. 5 shows an example of when two devices, D₁ and D₂, are not a Match with their location data as distance d is greater than r₁ and r₂.

The concept of multiple devices tapping at the same time is complicated by the fact that many devices have hardware and software that allows the local time to drift. It can be slow (e.g., the device thinks it is 12:45 PM when it is really 12:47 PM), or fast (e.g., the device thinks it is 12:50 PM when it is really 12:47 PM). This drift causes any recording of local time to be suspect and require an alignment to a trusted third party to first determine how far away the device's local time is to the “real” time of the third party. This is referred to as the time offset (210 in FIG. 2).

The present system may comprise a single or multiple trusted third parties. In this way, the trusted third party can be the same for all devices, or different for each device, so long as all trusted third parties have synchronized clocks. Non-limiting examples of methods for synchronizing time include a cluster of servers all utilizing the same NTP or PTP synchronization.

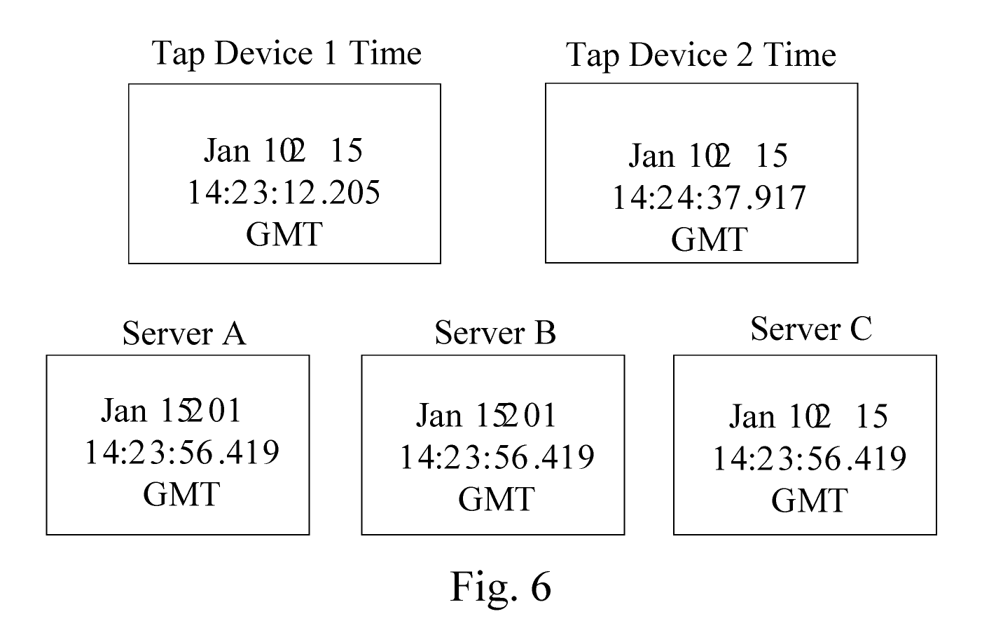

FIG. 6 illustrates the difference between local time on each device. In the illustrated embodiment, there are two user devices attempting to Tap. It is assumed that Servers A, B, and C all have the same local time due to being synchronized. Each user device has a different local time compared to “real” time. Device 1 has a local time of 14:23:12.205 whereas Device 2 has a local time of 14:24:37.917. This reflects time drift that can regularly occur among various devices. If time drift is not corrected, proper Matches may not be made between the two or more intended parties.

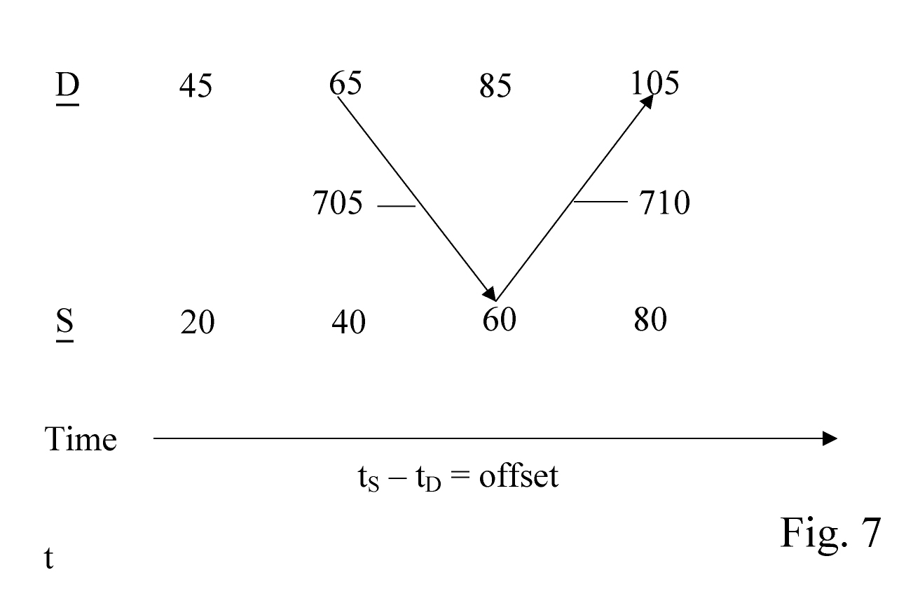

FIG. 7 shows a device D requesting the current time from a server S. The line marked 705 shows a Device D requesting the correct time from a server S. In the illustrated embodiment, the device's local time when it starts the request is 65; and the time that the server records the time upon receiving the request is 60. The server S then responds back to the device D on line 710 sending the correct time. The device D then records the local time as it receives the response at 105.

The difference between the request local time and the response local time (105−65=40), is 40. This is the total round trip time for requesting the correct time from the server. In the illustrated embodiment, the server responded some time between 105 and 65.

For the purposes of the present implementation, it is assumed that both the request and response time are symmetric; and the total round trip time is divided by two, then the quotient is added to the request time to align local and server time (40/2=20, 20+65=85). This would make the local time 85 when the server recorded. Using a simple equation of t_{S}−t_{D}=offset we get the offset of −25 (60−85=−25).

The assumption of symmetric requests and responses in calculating the offset lead to incorrect time values the more network latency there is between the device and the time server. Typically, this will be no more than a handful of milliseconds that can be accounted for when attempting to Match.

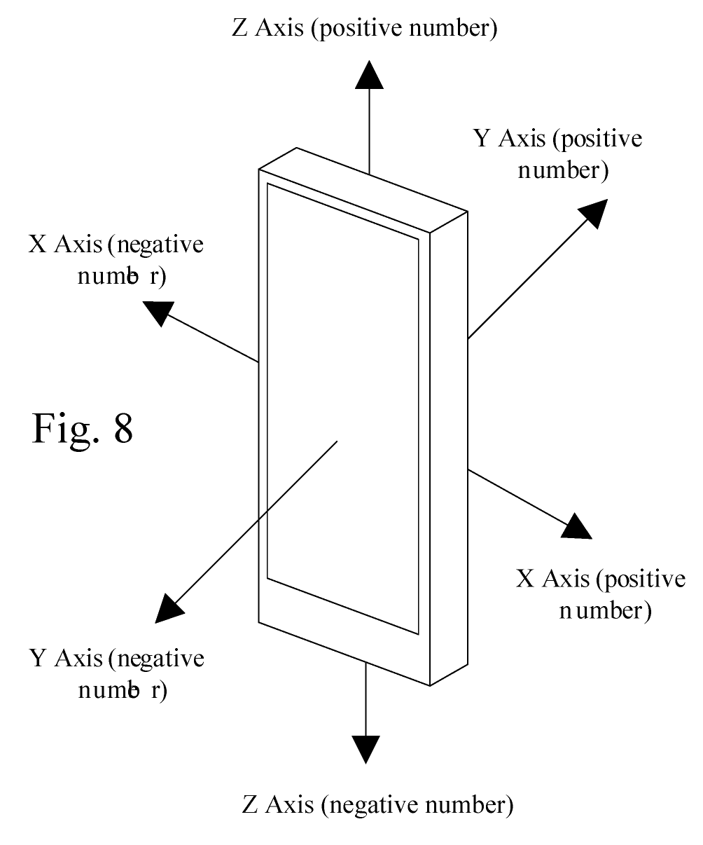

Additional data on top of Location and Time (i.e., same place, same time) is required to get an accurate Match between two devices Tapping. One piece of data that is recorded is the motion of each tap recorded in x, y, and z coordinates that represent three dimensions of movement. FIG. 8 shows how numeric values correspond to physical motion of a device. Forward motion will result in positive numbers, and backwards motion results in negative numbers. The same is true for all three axes.

When measuring events such as collisions or impacts, there are patterns that a computer can monitor and record. Assuming a device is recording the motion data from its motion sensing hardware, there will be a large increase in the X, Y, and Z values when an impact occurs. A simple way to measure intensity regardless of direction is by taking each value, squaring the value, then adding them all together. This is can be referred to as magnitude squared, or m² (m²=x²+y²+z²). This magnitude squared value will be similar when two devices impact with each other on each device.

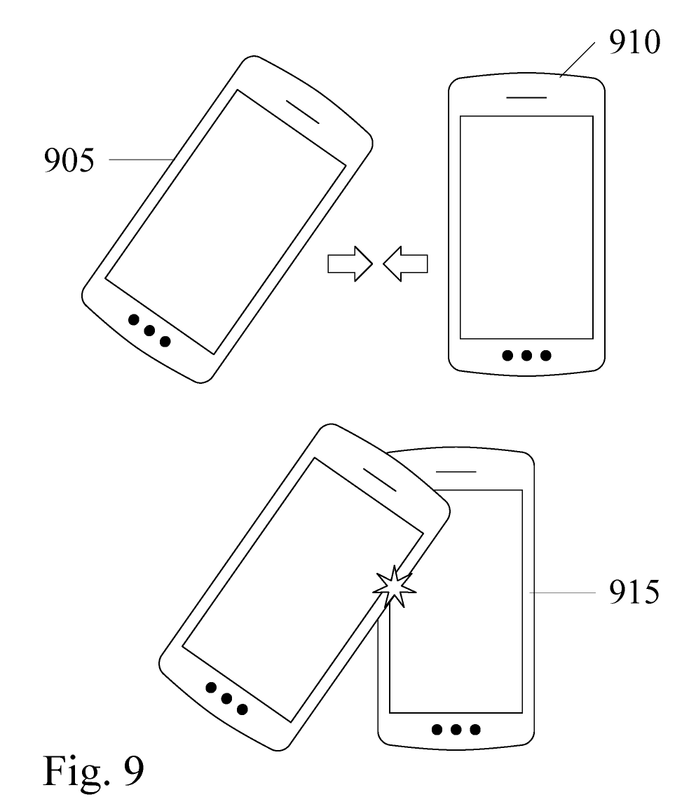

Two devices impacting with each other will have very similar magnitude squared values at the time of each impact. In this regard, it is contemplated that if the difference between two magnitude squared values is within a predetermined threshold, then the respective devices Match. This is another way to uniquely identify Tap Events. FIG. 9 shows two devices, 905 and 910 respectively coming together and impacting in 915.

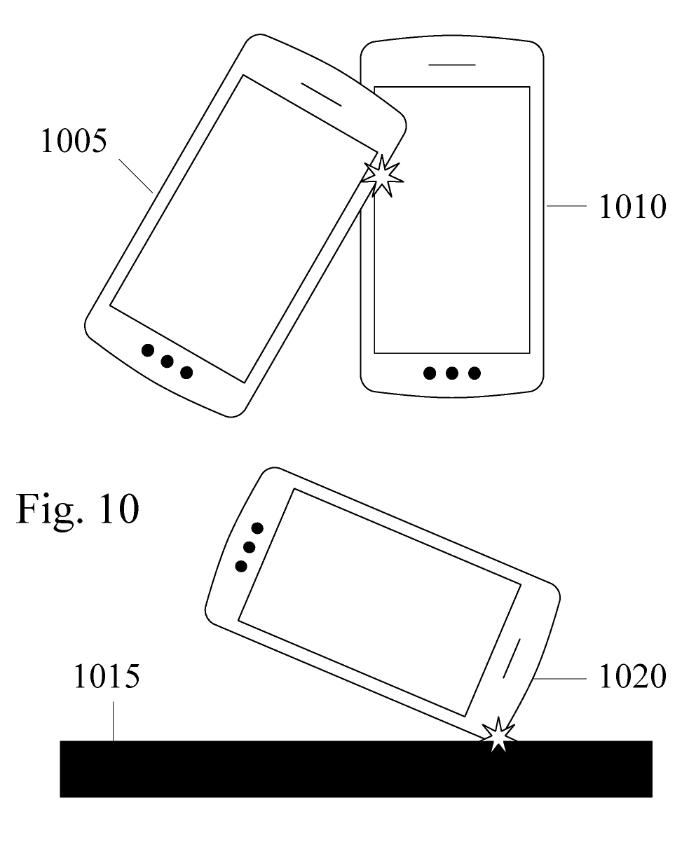

If the motion data was not being recorded there is the possibility for rogue users to attempt to Match with users that did not share their intent. For instance, if two people in a restaurant tap their phones together to attempt to Match, then a third user in the same restaurant could see the two people and tap his or her device against the table. All three users would then be in the same place and (roughly) the same time. FIG. 10 shows this scenario with 1005 and 1010 as the two people in the restaurant attempting to communicate with each other, while 1015 is the rogue user's device and 1020 is the table they are tapping.

When more than one Tap is included, and the time between the taps is recorded, it becomes very difficult to replicate the exact time between the two Taps down to the millisecond level. It also is difficult to replicate the exact intensity of two or more people impacting their phones together outside of the actual impact.

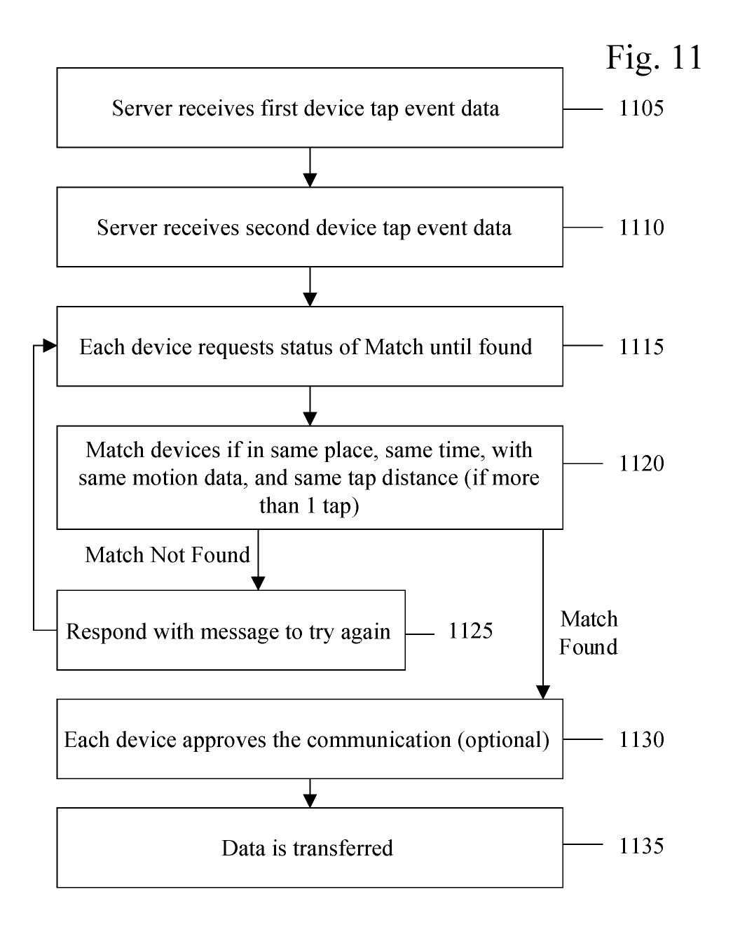

After the Taps have been transmitted to the server, the server will attempt to find a Match with the information provided in each Tap report. FIG. 11 shows this communication in detail. The two devices attempting to communicate send their Tap data (see FIG. 2. for the data sent) are 1105 and 1110 respectively. Each device will wait to find out if a match has been made. The server will then attempt to find a Match. Once both devices send their data, the Match will be made. Due to network latency, there may be a slight delay for some devices. Each device will continue to wait until a Match is found or they give up (i.e., after a predetermined amount of time) and notify the user that no Match was found.

When the server attempts to make a Match, it should use the most specific to least specific information available with a level of uncertainty included in its solution. Assuming the two devices that have communicated the time between multiple Taps, the Motion Data, the local time, the time offset and the Location, the server should look up all Taps it has stored within a range close to the values of each Tap.

When the first Device requests a Match be made, the Server should look up other Taps that have similar time between Taps, Motion data, corrected time, and location in that order. Each data point comprises some level of uncertainty when the Match is attempted. Non-limiting examples of the data points comprise a distance between Tap Locations.

Optionally, the present invention comprises the method step of requesting a user to verify a Match after the Match is made. This method step is particularly appropriate if the server finds more than one prospective Matches. In such embodiment, the users of all of the matched devices may be verified via security sensitive applications, flagging, or other similar means. It is contemplated that the users of all of the matched devices are verified before communication proceeds. If verification is not required or requested, then the communication will occur immediately after the Match is established by the Server.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A system, comprising:
a server in communication with a plurality of user devices in a network, wherein said plurality of user devices comprises a first user device and a second user device;
said server configured to:
i) measure a location, a time, and a motion of each of said plurality of user devices, wherein said motion comprises one or more taps;
ii) determine a time offset for each of said plurality of user devices; and
iii) determine whether said first user device and said second user device match.

2. The system of claim 1, wherein said plurality of user devices further comprises a third user device in communication with said network;
said server further configured to determine whether said third user device matches said first user device or said second user device.

3. The system of claim 1, wherein said server is further configured to determine multiple motion data records.

4. The system of claim 1, wherein said server is further configured to determine a time between taps.

5. A method of exchanging information between two or more user devices, comprising the steps of:
initiating a physical contact between a first user device and a second user device, wherein said physical device comprises one or more taps;
measuring a location, a time, and a motion of each of said first user device and said second user device;
generating a tap report comprising said one or more taps;
transmitting said tap report to a server;
off setting time for each of said first user device and said second user device; and
determining whether said first user device and said second user device match.

6. The method of claim 5, further comprising the steps of:
finding a second set of one or more taps that is substantially similar to said one or more taps.

7. The method of claim 5, wherein the step of off setting time comprises the steps of synchronizing time.

8. The method of claim 5, further comprising the steps of verifying said first user device and said second user device before establishing communication between said first user device and said second user device.
